(19) United States
(12) Patent Application Publication
(10) Pub. No.: US 2007/0122667 A1
(43) Pub. Date: May 31, 2007

(54) Fuel cell system with integrated fuel processor

(76) Inventor: Richard H. Kelley, Windham, ME (US)

Correspondence Address: CHRIS A. CASEIRO, VERRILL DANA, LLP, ONE PORTLAND SQUARE, PORTLAND, ME, 04112-0586, US

(21) Appl. No.: 11/288,775

(22) Filed: Nov. 28, 2005

(51) Int. Cl. H01M 8/06; H01M 8/04

(52) U.S. Cl. 429/19; 429/34; 429/20; 429/26

(57) ABSTRACT

A fuel cell system with fuel processor for integration with a marine vessel propulsion system. The system includes an auto thermal reactor that is the fuel processor for producing hydrogen from a fuel source. The fuel source is preferably ethanol or biodiesel or a mixture thereof, but can also be a sulfur containing fuel like petrodiesel of JP-8. The system further includes a gas-water shift reactor for further production and concentration of the hydrogen from the auto thermal reactor output. The system also includes a hydrogen permeable membrane separator for generating suitable quantities of essentially pure hydrogen to the fuel cell. The system also includes an oxygen permeable membrane separator for concentrating oxygen and reducing nitrogen to improve the partial pressure of hydrogen in subsequent fuel processing steps. The system contemplates the use of a Polymer Electrolyte Membrane (PEM) fuel cell. The system minimizes preheating of catalysts or other components to the extent just needed to initiate the fuel processor. To that end, heat sources and sinks of the system and associated usage systems are matched so as to minimize heat collection, storage and distribution systems. Water is recycled within the system to the extent necessary to maintain a water balance in the fuel processor and the fuel cell stack(s). The system includes cooling of the fuel cell stack(s) and integrated heat recovery with exothermic and endothermic catalysts. The fuel processor/fuel cell system components are configured to conform to and take advantage of the available space and limitations, such as the space constraints and opportunities associated with a marine vessel.

### BACKGROUND OF THE INVENTION

1. Field of the Invention

The present invention relates to fuel cell systems. More particularly, the present system relates to fuel cell systems used as propulsion for marine vessels. Still more particularly, the present invention relates to the integration of fuel cells, particularly Polymer Electrolyte Membrane (PEM) fuel cells, into marine propulsion compartments. The present invention includes a biofuel processor integrated with a PEM fuel cell and electric propulsion drive and AC/DC electric power systems.

2. Description of the Prior Art

In view of the many limitations associated with the use of conventional fossil fuels as a source of power for everything from power generation systems to mechanical equipment to vehicles, much effort has been focused on the use of alternative fuel sources. Among others, fuel cells have been shown to be of some promise. In simple terms, a fuel cell operates much like a battery. It includes catalytic cathodes and anodes separated by electrolyte material. In the PEM fuel cell, for example, hydrogen gas associated with the anode contacts the catalyst on its way to the cathode to interact with oxygen at the cathode. As the hydrogen contacts the catalyst, it dissociates into protons and electrons. The protons move through the electrolyte to the cathode. The electron does not take the same path to the cathode. Instead, it forms part of an electrical circuit in that it passes through a conductive medium joining the anode and the cathode. The protons join with oxygen and electrons at the cathode to produce water. Electricity produced during the process of the hydrogen dissociation may be tapped for usage as a battery. Of course, the electricity produced may be used for other purposes, such as for a direct current motor or through an inverter for an alternating current motor, and other electricity use applications. Further, it is to be noted that there are other types of fuel cells, including phosphoric acid, alkaline, molten carbonate, and solid oxide, that may be employed in the application to be described herein. However, marine vessel functions are the focus of the present invention with the description concentrated on, but not limited to, the use of a PEM type fuel cell.

Important advantages associated with fuel cells include use of a fuel source other than a fossil fuel, little to nothing in the way of water pollution and significant reductions in undesired air emissions. There are currently, however, a number of limitations associated with fuel cells, which limitations to date have rendered them unacceptable on a broad scale. Specifically, they may have to be quite large to generate the sort of power considered useful for large-scale functions, such as commercial ships. In addition, they must be very efficient and comparable in cost to internal combustion and diesel engines and produce suitable power for smaller scale functions, such as automobiles. Further, there must be an adequate supply of hydrogen as the fuel source to make PEM fuel cell operation viable.

Currently, most marine vessels are powered using conventional fossil fuels. The use of these fuels produces pollution and, as presently understood, there is a finite supply. There are additional hazards uniquely associated with the use of fossil fuels in a marine environment. Specifically, fouling and contamination of the body of water through which the vessel travels may occur through introduction of fuel or oil into the body of seawater or fresh water via spills or discharges of bilge water or ballast. It would therefore be desirable to have an available alternative mechanism for marine vessel propulsion and electricity supply that excludes the use of fossil fuels. Unfortunately, while much effort and money has been put into fuel cell technology for motor vehicle and public power supply, relatively little has been expended to focus on the possible introduction of fuel cells into marine vessel propulsion systems. Examples of alternative power source methods have been described in the Background section of U.S. Pat. No. 6,610,193 issued to Schmitman. The contents of that Background are incorporated herein by reference. One example of an alternative fuel supply is biofuel, which is described herein. Among other things, the adoption and use of biofuels may extend the supply of fossil fuels.

While the concept of the introduction of a fuel cell power source to a marine vessel is understandable, a limitation of particular note is accessibility to hydrogen fuel for the cell. Personal marine vessels, such as powerboats, yachts, sail boats with motors (to a degree), all currently have the limitation of the extent of permitted travel based on proximity to a fuel source. There exist public marinas where the vessel may be stocked with fossil fuel. However, the use of a fuel cell as the primary power source could be undermined by the difficulty in accessing a suitable fuel therefor. As a result, a fuel cell system suitable for use in a marine vessel must consider a suitable arrangement for providing suitable fuel to the fuel cell in a manner that does not unduly burden the vessel operator. For the purpose of this description, “suitable fuels” are non-fossil fuels including, for example, biofuels.

Therefore, what is needed is a fuel cell based system for supplying power that does not require fossil fuels as the fuel source. Further, what is needed is a fuel cell power system that may be adapted for use in a marine vessel, particularly including noncommercial marine vessels. Still further, what is needed is such a fuel cell power system including some form of fuel source capable of integration with available fuel cell systems to provide hydrogen. What is also needed is such a fuel cell power system including an integrated fuel source or fuel generator adaptable for use with the fuel cell within the framework of the vessel structure.

### SUMMARY OF THE INVENTION

It is an object of the present invention to provide a fuel cell based system for supplying power that does not require fossil fuels as the fuel source. Further, it is an object of the present invention to provide a fuel cell power system that may be adapted for use in a marine vessel, particularly including noncommercial marine vessels. Still further, it is an object of the present invention to provide a fuel cell power system including a fuel source capable of integration with available fuel cell systems to provide hydrogen. It is also an object of the present invention to provide a fuel cell power system including an integrated fuel source or fuel generator adaptable for use with the fuel cell within the framework of the vessel structure.

These and other objects are achieved by the present invention, which is a fuel cell system with fuel processor. The primary application of the invention is directed to marine propulsion, but not limited thereto. The system contemplates use of ethanol or biodiesel as a fuel source in the process of hydrogen generation. The system also contemplates the use of a Polymer Electrolyte Membrane (PEM) Fuel Cell. Further, the system minimizes preheating of catalysts or other components to the extent just needed to initiate and sustain the fuel processor. To that end, heat sources and sinks of the system and associated usage systems are matched so as to minimize heat collection, storage and distribution systems. It is further contemplated that water will be recycled within the system to the extent necessary to maintain a water balance in the fuel processor and the fuel cell stack(s). The system includes a water jacket to cool the fuel cell stack(s), rejection of low-grade heat to the body of water in which the vessel resides, and integrated heat recovery with exothermic and endothermic catalysts. These distinct types of catalysts are nested together to maximize heat utilization. Additionally, the fuel cell stack(s) and supporting equipment are insulated and electrically heated to prevent freezing when not in use. The fuel processor/fuel cell system components are configured to conform to available space limitations, such as the space constraints associated with a marine vessel, such as a yacht, and take advantage of the unique available space relative to available space in automobiles and other over-the-road vehicles.

In one embodiment of the invention the fuel processor/fuel cell system may be joined with a propulsion system of a marine vessel to power the vessel rather than using conventional fossil fuels. However, the fuel processor/fuel cell system may alternatively be used in other applications for which an alternative fuel source and powering mechanism are desired. The fuel processor/fuel cell system includes an oxygen separator for introduction of that component to the fuel processor, a hydrogen separator for introduction of that component to the fuel cell, an auto-thermal reactor that is the main processor for producing the hydrogen, a water-gas shift reactor to produce additional hydrogen, and a fuel cell to produce the electricity to operate the vessel's propulsion motors as well as other motors and electronic devices. Additional process components may further be included as part of the system, such as heat exchangers, pumps, compressors and combustors to be described in the detailed description of the invention.

An important aspect of the fuel processor/fuel cell system is the operation of the fuel processor. The fuel processor is preferably supplied by a hydrogen-carrying source. More preferably, the source is a biofuel, such as ethanol, biodiesel, or mixtures of ethanol and biodiesel. While there is an extensive ethanol supply and distribution system within the United States, it is primarily used for providing blends of ethanol in gasoline as an octane booster in lieu of MTBE, which has fallen out of favor due to its propensity to leak from fuel tanks and contaminate drinking water supplies. While alcohol use in the marine industry has a long history (primarily as methanol used in on-board cooking stoves), it presents moderate challenges as a primary source of fuel owing to its relatively low energy density. Biodiesel on the on the other hand, has a more typical liquid fuel energy density, is readily adaptable to existing supply and delivery systems, requiring minimal delivery system checks and modifications (principally hose and gasket compatibility for older diesel systems). Biodiesel is a liquid biofuel suitable as a diesel fuel substitute or diesel fuel additive or extender. Biodiesel fuels are typically made from virgin or recycled vegetable oils such as soybeans, rapeseed, or sunflowers, or from animal tallow. Biodiesel can also be made from hydrocarbons derived from agricultural products such as rice hulls. Biodiesel is simply the cleaved branches of tri-glyceride molecules (vegetable oils in the preferred case) that result from the esterfication of tri-glycerides with alcohol using sodium hydroxide or potassium hydroxide catalyst, with glycerin (or glycerol) as a byproduct. The alcohol is either ethanol or methanol, with esterification of the oil using ethanol yielding an ethyl ester, and the esterification of the oil with methanol producing a methyl ester, the ethanol, unlike the methanol, not being a pollutant.

The auto thermal reactor that is a principal component of the fuel processor of the present invention is used to produce hydrogen from the biofuel. The water gas shift reactor, another principal component, makes additional hydrogen via the Water Gas Shift (WGS) reaction (CO+H₂O⇄H₂+CO₂). Hydrogen separation membranes embedded in the WGS reactor enhance the conversion to hydrogen, and a bulk gas hydrogen membrane separator, another principal component, works in conjunction with the WGS hydrogen separation membranes to provide an essentially pure hydrogen fuel to the fuel cell's anode. All of the fuel processor components must be sufficiently integrated and controlled to efficiently produce hydrogen to supply the fuel cell for its intended electrical output. Catalytic waste gas combustors and heat exchangers provide heat and water integration to maximize thermodynamic efficiency and minimize fuel processor component sizes. There are a wide variety of commercial and developmental catalysts that may be used in the present invention to maximize efficiency, but there are no existing commercially available reactors that are suitable for this purpose and described herein. The reactors, along with the other components of the fuel processor and fuel cell system are preferably shaped and arranged to conform to the conventional structure of the marine vessel. That is, the fuel processor components are fabricated with a slim profile to fit within the space constraints and conventional footprints and cavities of marine vessels. Portions of the fuel cell stacks may also be fabricated and arranged to fit within the space constraints and conventional footprints and cavities of marine vessels, such as the bow area, and other spaces not available in mass mobile vehicle markets.

It should be noted that for marine applications in particular, fuel cost and availability are two, but not the only, factors in the consideration of adopting alternative fuels suitable for use in the fuel processor. Other factors, including the environmental advantages of using alternatives to fossil fuels and the reduction of noise caused by conventional power generators, make fuel cell systems perhaps more desirable in this market than in mass mobile vehicle markets. It is also to be noted that biodiesel has high cloud points relative to petrodiesel, i.e., it tends to gel at temperatures in the range of 25 to 35 F as opposed to about −25 F for petrodiesel. Using mixtures of Ethanol and biodiesel will lower the cloud point, thereby improving cold flow properties. Therefore, in certain geographic areas, biofuel mixtures may be preferred rather than use of biodiesel only. The present invention is configured to enable the conversion of biofuels and mixtures of biofuels to produce the gases required for operation of the fuel cell.

These and other advantages and aspects of the system and related method of fabrication of the present invention will become apparent upon review of the following detailed description, the accompanying drawings, and the appended claims.

### BRIEF DESCRIPTION OF THE DRAWINGS

FIG. 1 is a simplified elevation view with partial cutaway of a yacht including an integrated fuel processor/fuel cell system of the present invention.

FIG. 2 is a simplified plan view of the engine compartment and forward storage spaces of a marine vessel such as the yacht shown in FIG. 1 including a first arrangement of the integrated fuel processor/fuel cell system of the present invention.

FIG. 3, comprising FIG. 3A and FIG. 3B, is a system diagram showing the primary components and fluid flows of the integrated fuel processor/fuel cell system of the present invention in the structural arrangement of FIG. 2.

FIG. 4 is a simplified plan view of the engine compartment and forward storage spaces of a marine vessel including a second arrangement of the integrated fuel processor/fuel cell system of the present invention.

FIG. 5, comprising FIG. 5A and FIG. 5B, is a system diagram showing the primary components and fluid flows of the integrated fuel processor/fuel cell system of the present invention in the structural arrangement of FIG. 4.

FIG. 6 is a simplified plan view of the engine compartment and forward storage spaces a marine vessel including a third arrangement of the integrated fuel processor/fuel cell system of the present invention.

FIG. 7, comprising FIG. 7A and FIG. 7B, is a system diagram showing the primary components and fluid flows of the integrated fuel processor/fuel cell system of the present invention in the structural arrangement of FIG. 6.

FIG. 8 is a simplified plan view of the engine compartment and forward storage spaces a marine vessel including a fourth arrangement of the integrated fuel processor/fuel cell system of the present invention.

FIG. 9, comprising FIG. 9A and FIG. 9B, is a system diagram showing the primary components and fluid flows of the integrated fuel processor/fuel cell system of the present invention in the structural arrangement of FIG. 8.

FIG. 10 is a simplified plan view of the engine compartment and forward storage spaces a marine vessel including a fifth arrangement of the integrated fuel processor/fuel cell system of the present invention.

FIG. 11, comprising FIG. 11A and FIG. 11B, is a system diagram showing the primary components and fluid flows of the integrated fuel processor/fuel cell system of the present invention in the structural arrangement of FIG. 10.

FIG. 12 is a simplified plan view of the engine compartment and forward storage spaces a marine vessel including a sixth arrangement of the integrated fuel processor/fuel cell system of the present invention.

FIG. 13, comprising FIG. 13A and FIG. 13B, is a system diagram showing the primary components and fluid flows of the integrated fuel processor/fuel cell system of the present invention in the structural arrangement of FIG. 12.

FIG. 14 is a block diagram showing the major process flows and electrical, process and safety controls of the integrated fuel processor/fuel cell propulsion system of the present invention.

FIG. 15 is a simplified side view of an example hydrogen permeable membrane unit embedded in a water-gas shift reactor.

FIG. 16 is a close-up side view of one tube of the example hydrogen permeable membrane unit of FIG. 15.

### DETAILED DESCRIPTION OF THE PREFERRED EMBODIMENTS

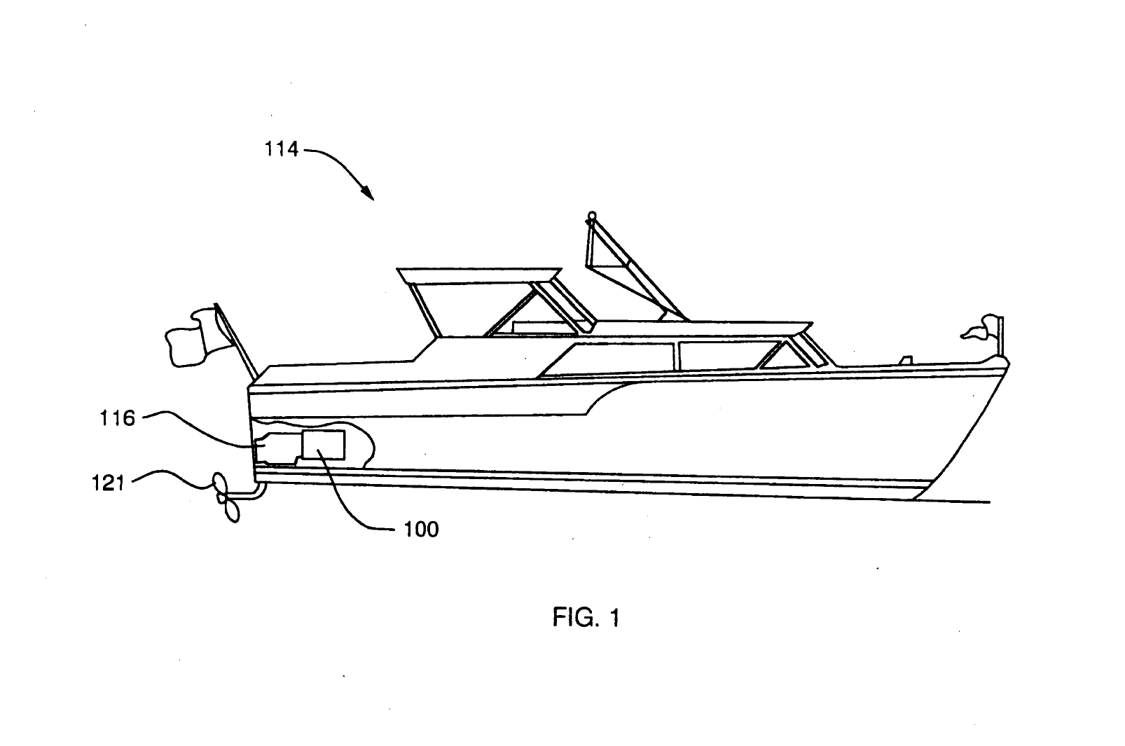

A fuel processor/fuel cell system 100 of the present invention is shown in FIG. 1 integrated with a propulsion system 112 of a marine vessel 114, which may include, but not be limited to a yacht. Additionally, it is to be understood that the fuel processor/fuel cell system 100 may be used in association with other systems and devices requiring electricity, principally electric drives for propulsion and maneuvering, an inverter to make AC electric power for house loads and a DC battery storage system. The propulsion system 112 may include an electrical motor 116 coupled to a propulsor, such as a propeller 121. The electrical motor 116 and the propeller 121 may be of any type associated with marine vessels. They may be sized for the particular size and operating characteristics of the vessel 114.

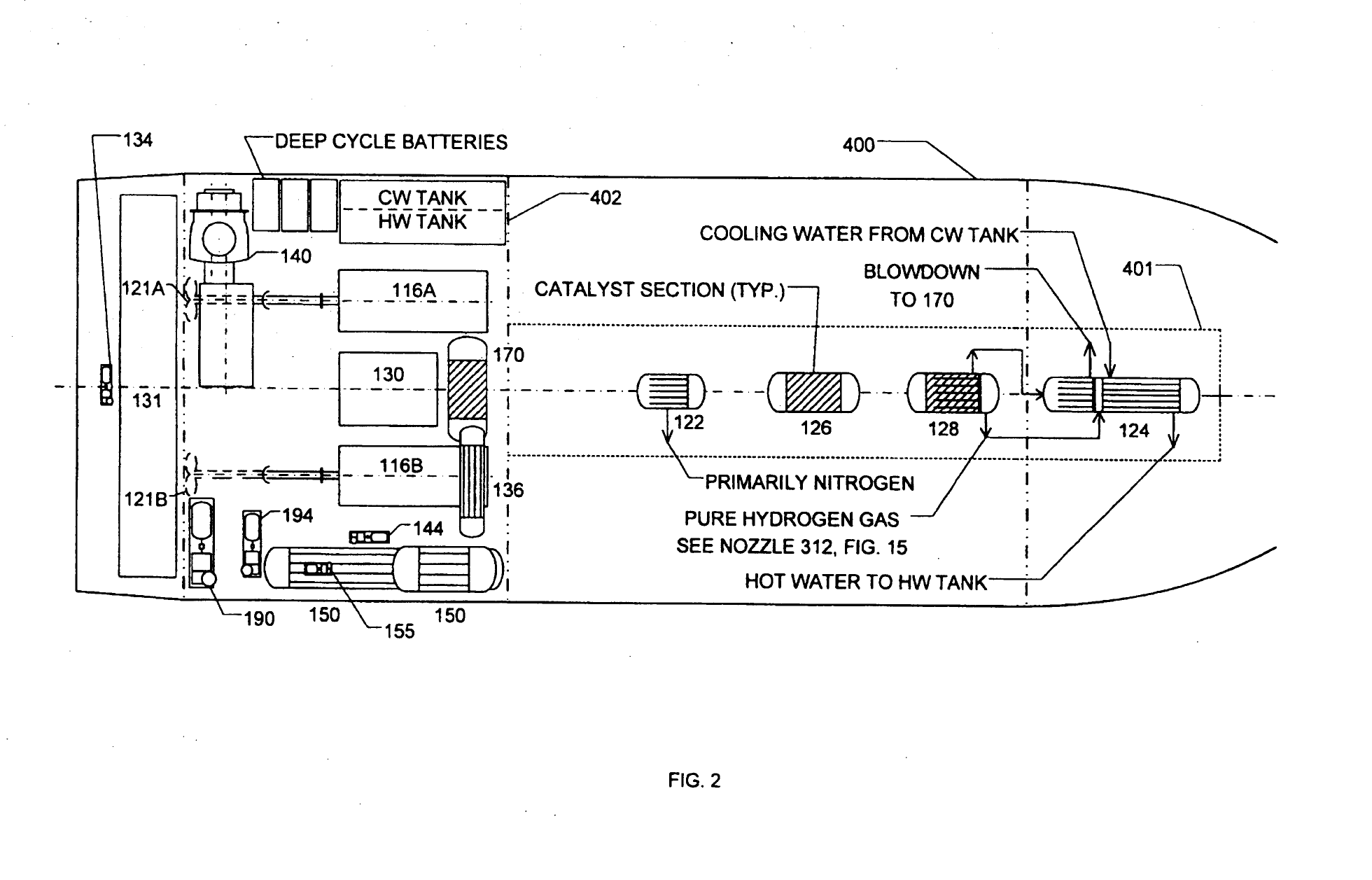

A first embodiment of the fuel processor/fuel cell system 100 of the present invention for use in a marine vessel of relatively substantial size and a biofuel as a fuel source is shown structurally in FIG. 2 and schematically in FIG. 3 comprising FIGS. 3A and 3B. The fuel processor/fuel cell system 100 is configured and arranged to fit within the boundaries defined by the vessel. In particular, by the hull 400, a first structural stringer 401 beneath a cabin sole, a first bulkhead 402 separating the vessel's engine room from its cabin, one or more engine room structural stringers represented by second structural stringer 403 within the engine room, and a second bulkhead 404 separating the vessel's engine room from its fuel tank space. The fuel processor/fuel cell system 100 includes as primary components an oxygen membrane separator 122, a hydrogen membrane separator 124, an auto-thermal reactor 126, a water-gas shift reactor 128, and a fuel cell 130. The operation of the fuel cell 130 produces electricity that may be directed in an electrical path including the electrical motor 116 shown as a twin set of motors 116A and 116B used to move the propeller 121 shown as a twin set of propellers 121A and 121B. Alternatively or additionally, the electricity produced by the fuel cell 130 may be directed in an electrical path to more than one propulsion motor and an electrical bus and inverter for use in other DC or AC applications, such as the vessel's internal power needs. The oxygen membrane separator 122 may be an optional component of the system 100 in that the oxygen source may come directly from air dependent upon the requirements for purity of at least the hydrogen directed to the fuel cell 130. A fuel tank 131 shown aft of the fuel cell 130 provides a supply of fuel for the operation of the fuel processor/fuel cell system 100.

The fuel processor/fuel cell system 100 integrated into the vessel's shape may be accessed through one or more access hatches located in the floor of the marine vessel 114. Moreover, the fuel processor/fuel cell system 100 may include a space cooling system, including one or more blowers, to keep below decks spaces containing the fuel processor/fuel cell system 100 from overheating. The interconnecting piping for fluid transfer, which piping is represented by streams as identified herein, may be configured as “hard piping,” as that term is understood by those skilled in the field of marine vessel piping, to impede unintended intrusion of contaminants into the fuel processor/fuel cell system 100. At the same time, the interconnecting piping may also include engineered internal, scoured grooves that can be cut open for service by authorized personnel. Further, the interconnecting fuel processor piping may be insulated and electrically heat traced using intermittent DC electrical power from the fuel cell 130 when the vessel is idle, or shore power when the vessel is berthed, for protection from freezing during cold weather operation. It is to be noted that the interconnections described herein may be flanged, face-to-face, integral or the like. The particular means of interconnection is not important in relation to the sequence of interconnections.

In basic operation, the fuel processor/fuel cell system 100 of FIGS. 2 and 3A-3B intakes a fuel source retained in fuel tank 131, or from another selectable location, at first intake 132 through ducting represented by Stream 1 by first pump 134. The fuel source is preferably a biofuel, and more preferably it is a mixture of ethanol and biodiesel. The first pump 134 directs the biofuel source through ducting represented by Stream 3 to heat exchanger 136 for vaporization before delivery to the auto-thermal reactor 126. Recycled water from Stream 9A, to be described herein, required for reactions in auto-thermal reactor 126 is introduced with liquid fuel in Stream 3 and vaporized along with fuel and fed to the auto-thermal reactor 126. Second intake 138 intakes air, which may be unfiltered but is preferably filtered through filter 141, through ducting represented by Stream 2 to compressor 140. The intake air may first be scrubbed in scrubber 142 using water reuse/recycle tapped by ducting represented by Stream 30 from Stream 5, which is cooled water formed by the reaction of hydrogen and oxygen in the fuel cell 130 and routed using pump 144. The compressed air passing from compressor 140 is directed to the oxygen separator 122 through ducting represented by Stream 20B. The scrubbing water and contaminants exit the scrubber 142 to outlet 155.

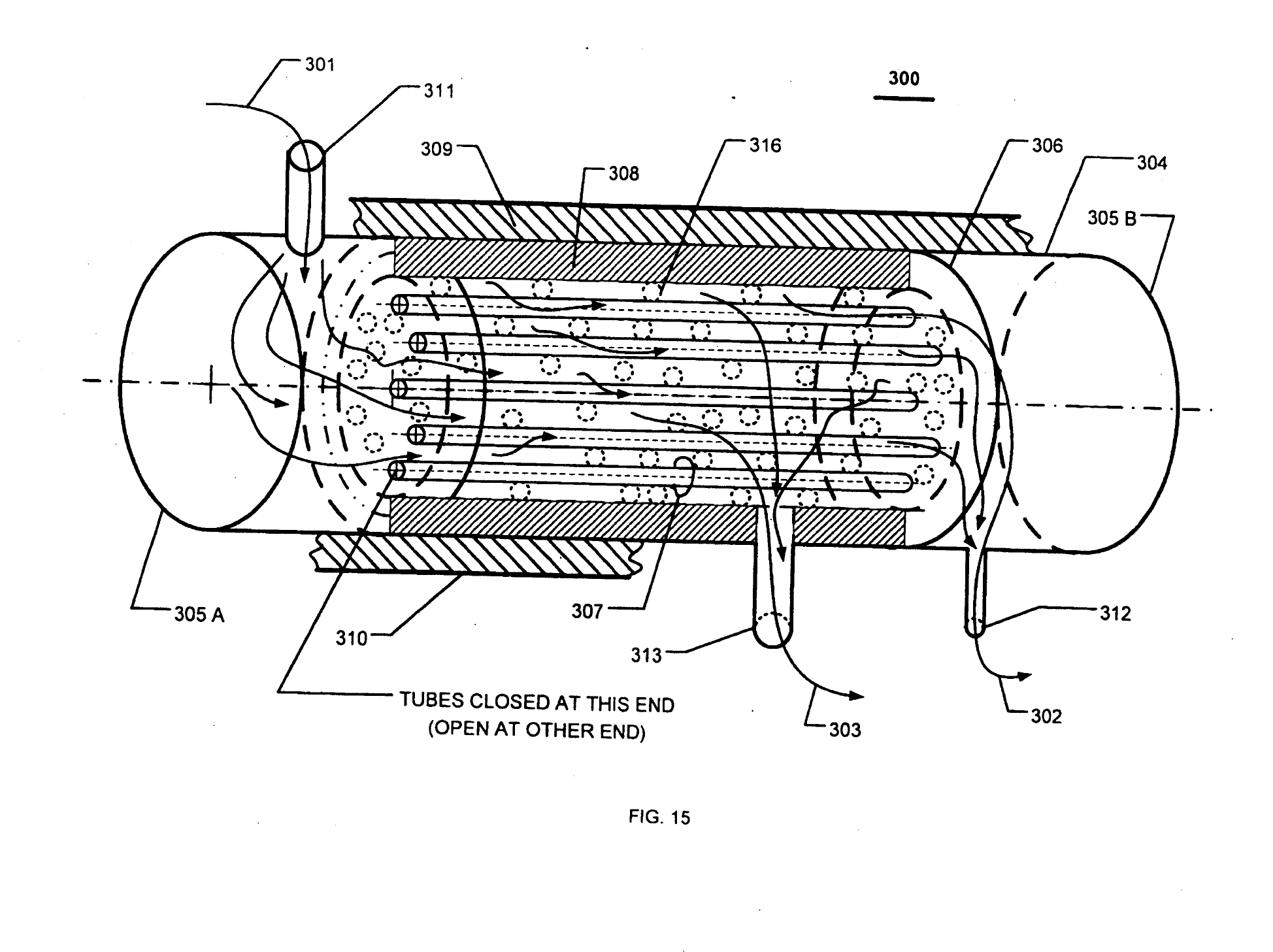

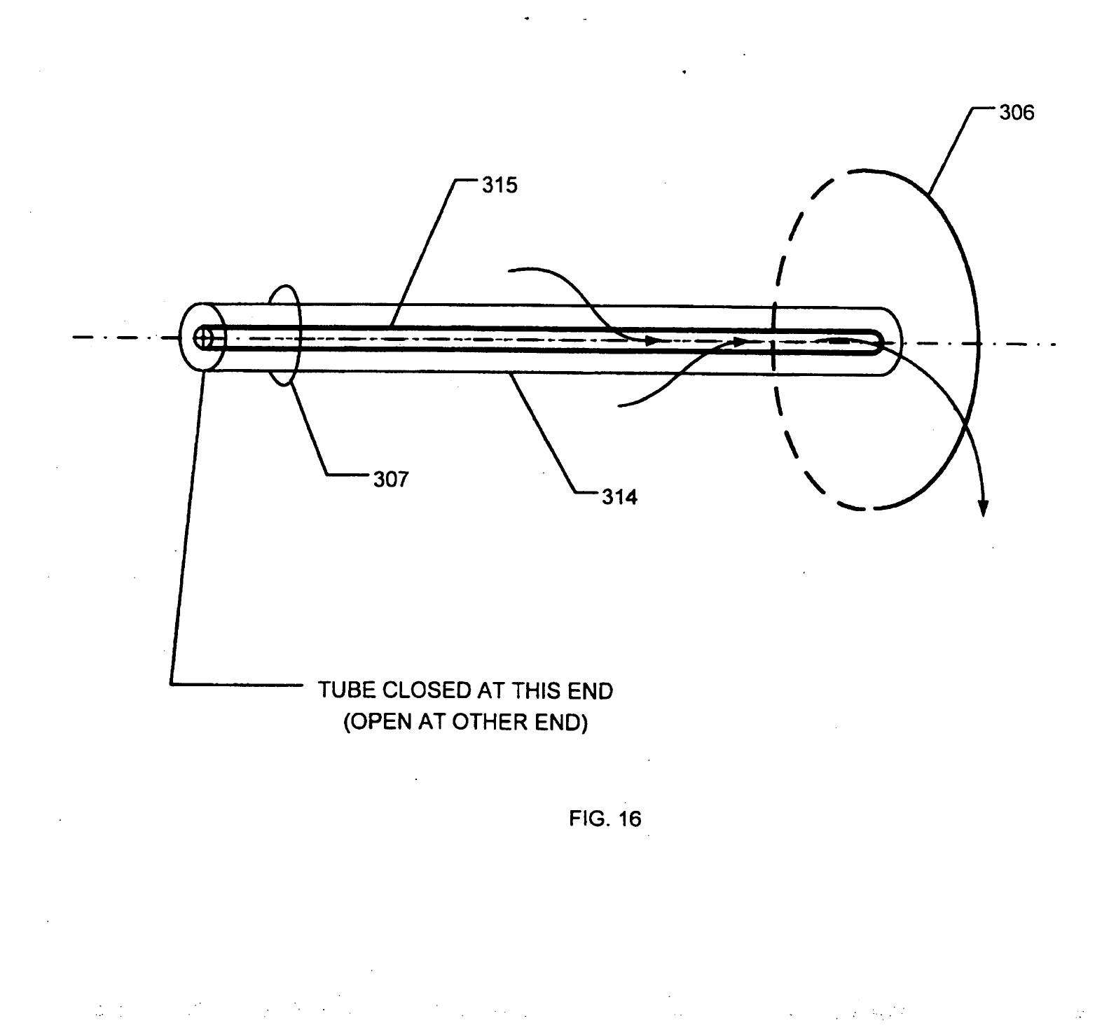

The oxygen membrane separator 122 separates a large fraction of oxygen from the incoming air, exhausts the balance, primarily nitrogen, to the atmosphere through pressure relief valve 123 to nitrogen vent 157. It further directs the oxygen rich stream via ducting represented by Stream 4 to ducting represented by Stream 6. The oxygen membrane separator 122 may be any type of device suitable for isolating oxygen from a gas mixture. An example separator is described herein with respect to FIGS. 15 and 16; however, those skilled in the art will recognize that the specific design of the oxygen membrane separator 122 is not as important as the general proposition of having some means for concentrating oxygen for delivery to the fuel cell 130. The oxygen membrane separator 122 may be necessary in the case where the purity of the hydrogen entering the fuel cell 130 is particularly important. That is, the oxygen membrane separator 122 may be required if it is necessary to purify hydrogen such as through use of the hydrogen membrane separator 124 to be described. Specifically, there is significant pressure drop across the hydrogen membrane separator 124, which reduces the partial pressure of hydrogen into the fuel cell 130 when air is used in the auto-thermal reactor 126. To overcome this, the use of the oxygen membrane separator 122 to reduce the partial pressure of other air gases otherwise entering the fuel cell 130 and increase the partial pressure of the hydrogen. Heat for vaporization of the fuel and water heat exchanger 136 is provided via combustion of residual gases, and utilization of sensible heat contained therein, from catalytic combustor 170 to be described herein. Exhaust from heat exchanger 136 is directed through ducting represented by Stream 10 to a condenser 150 to be described herein.

Stream 6 represents ducting comprising a mixture of the oxygen and the vaporized biofuel and water mixture from heat exchanger 136. Stream 6 and its contents form a fuel processor subsystem of the fuel processor/fuel cell system 100 including the auto-thermal reactor 126. The auto-thermal reactor 126 may be an adiabatic reactor. The principal output of the auto-thermal reactor 126 is hydrogen formed by vapor phase reaction of the biofuel with steam and oxygen. The output is directed through ducting represented by Stream 8 to the water-gas shift reactor 128 for additional processing and hydrogen generation.

With continuing reference to FIGS. 2-3B, the fuel processor/fuel cell system 100 further includes the water reuse/recycle Stream 5 formed by the reaction of hydrogen and oxygen in the fuel cell 130 and used for cooling and desuperheating of process streams and as a source of steam for further production and generation of hydrogen via the water gas shift reaction described previously, through ducting represented by Stream 5 by second pump 144. Pump 144 pumps water directly from the output of condenser 150 to be described herein. It is to be noted that first pump 134 and second pump 144 may be selected and arranged to suit the fluid transfer requirements of the fuel processor/fuel cell system 100 for the particular electricity needs identified. The water is then split from Stream 5 into two coolant ducts, represented by Stream 9 and Stream 13. Specifically, Stream 9 provides water input to a first spray water desuperheater 180 for cooling of the gas from the output of the auto-thermal reactor 126 and to provide additional steam to the water-gas shift reactor 128. The coolant of split Stream 9, Stream 9A is sent to the heat exchanger 136 where it is vaporized with fuel and then sent via Stream 6 to the auto-thermal reformer 126 to participate in reactions to produce hydrogen. The water from Stream 9, Stream 9B, is combined through first spray water desuperheater 180 with the hydrogen output of the auto thermal reactor 126 of Stream 8 to form a mixed fluid of additional vaporized water and gaseous hydrogen carried in ducting represented by Stream 11 to the water-gas shift reactor 128. The water-gas shift reactor 128 may be an adiabatic reactor. The water-gas shift reactor 128 operates to draw hydrogen from the reaction zone to output Stream 29. This promotes the conversion of additional hydrogen in the reaction zone of the water-gas shift reactor 128. The essentially pure hydrogen in Stream 29 preferably is combined with hydrogen in Stream 18, resulting in hydrogen Stream 19 to be described herein.

Stream 13 carrying water from recycle stream 5 is split in part to a second spray water desuperheater 182 for cooling of the gas from the water-gas shift reactor 128. The output of the water-gas shift reactor 128 through ducting represented by Stream 12 is directed, along with the water of Stream 13 through desuperheater 182 to ducting represented by Stream 15 directly through ducting represented by Stream 16 to the hydrogen separator 124. The hydrogen separator 124 may be any type of device suitable for isolating hydrogen from a gas mixture, including the permeable membrane unit described with respect to FIGS. 15 and 16. For example, it may a chamber including a series of porous tubes packed with material that will pass hydrogen and not other gases, such as a Palladium membrane. Those skilled in the art will recognize that the specific design of the hydrogen membrane separator 124 is not as important as the general proposition of having some means for concentrating hydrogen for delivery to the fuel cell 130. The hydrogen membrane separator 124 may be necessary in the case where the purity of the hydrogen entering the fuel cell 130 is particularly important. Water split from Stream 13 to ducting represented by Stream 34 is used to cool the hydrogen, leaving hydrogen separator 124 prior to being delivered to the fuel cell 130. The hot water generated is transferred through ducting represented by Stream 35 to outlet 156, which may be directed to the vessel's potable hot water tank or other suitable on-board uses.

The hydrogen separator 124 isolates purified hydrogen for transport through ducting represented by Stream 18, and is combined with hydrogen from the water-gas shift reactor 128 at ducting represented by Stream 19, as previously noted. The hydrogen of Stream 19 is then sent to humidifier 184. Warm water from Stream 14, to be described herein, is sprayed in mist form and mixed with the hydrogen of Stream 19 in humidifier 184. Humidified hydrogen is then sent in the ducting represented by Stream 21 to the anode chamber 162 of fuel cell 130. The oxygen supplied to the fuel cell 130 through Stream 20 is as a component of air that has been filtered, cooled, humidified or otherwise prepared prior to entry to the fuel cell cathode chamber 160 of the fuel cell 130. As illustrated in FIGS. 2-3B, the oxygen in Stream 20 is provided from an intermediate bleed point from the compressor 140. Exhaust gases from the hydrogen separator 124 are directed through ducting represented by Stream 17 to pressure relief valve 148 to catalytic combustor 170 for combustion of reaction gases from the hydrogen separator 124, recovery of sensible heat, preheating of recycled water for humidification of hydrogen and oxygen and vaporization of the fuel and water for reaction in the auto thermal reactor 126. Further, a portion of the bleed air from the compressor 140 is directed to the catalytic combustor 170 as combustion air by ducting represented by Stream 20A.

The fuel cell 130 supplied by hydrogen Stream 21 and oxygen Stream 20 operates to produce electricity forming part of circuitry to run the electrical motors 116 A and B. Fluid output from the fuel cell is primarily water vapor and nitrogen exhausted from the cathode 160 and occasionally blow down of impurities from the anode 162 thereof. The exhaust water vapor is transported through ducting represented by Stream 22 to condenser 150. Exhaust from the anode 162 is also directed, through ducting represented by Stream 36, to the condenser 150 via Stream 22. Heated exhaust gas from the heat exchanger 136 is also directed to the condenser 150 through ducting represented by Stream 10. The fluids of Streams 22 and 10 are condensed using a coolant, such as water, with the non-condensable gas portion of these streams vented through blower 155 as exhaust 152, and condensed water either discharged at discharge 154, or otherwise transported for other uses within the system of the present invention. Cooled water discharged at discharge 154 may be directed to the vessel's potable cold-water tank or other suitable on-board uses.

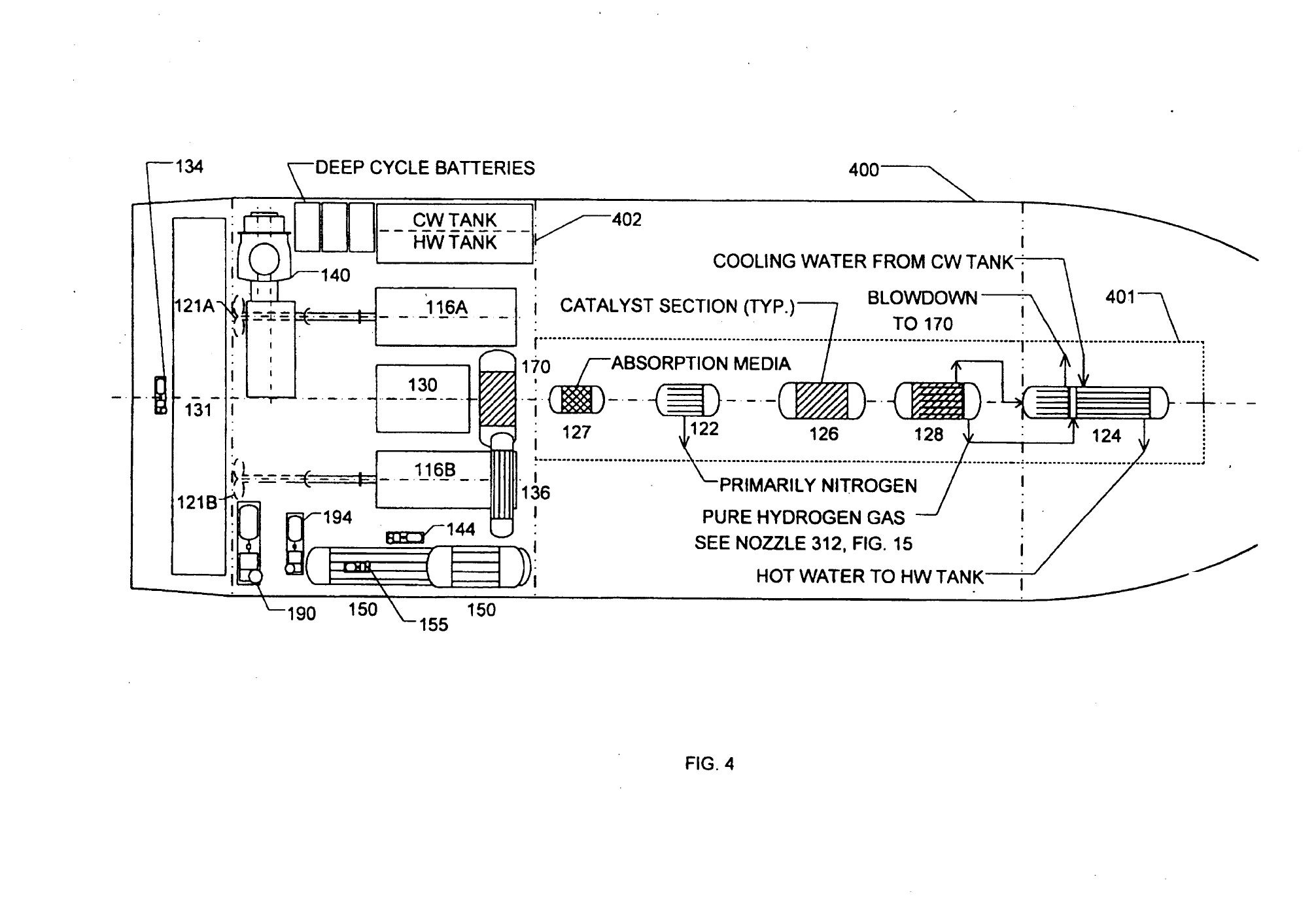

With continuing reference to the fuel cell 130 of the fuel processor/fuel cell system 100 as shown in FIGS. 2-3B, and generally in regard to FIGS. 4-13B, it is preferably arranged and operates as follows. Filtered air at Stream 2 passes through compressor 140, which outputs compressed air to Stream 20. The compressed air is humidified at air humidifier 158 before entering the fuel cell 130 at cathode chamber 160. Additionally, formed hydrogen from the auto-thermal reactor 126 exits through ducting represented by Stream 8 and passes through desuperheater 180 to control gas temperature. Further, a portion of the formed hydrogen may exit an optional hydrogen separation membrane embedded in the water-gas shift reactor 128 via ducting represented by Stream 29 to combine with the output of purified hydrogen from the hydrogen separator 124 at Stream 18 to form the fuel cell hydrogen fuel supply at Stream 19. Heated water passing through heat exchanger 136 is directed to the humidifiers 184 and 158 through ducting represented by Stream 7 and split into streams 14 and 14A, which result from the coolant output from the heat exchanger 136 provided by Stream 31. As noted, the fuel cell 130 produces electricity, which may be coupled to a system requiring electricity, such as electric motors 116 A and B.

Heated coolant exiting the cooling loop of fuel cell 130 through ducting represented by Stream 26 is also directed to the condenser 150 for cooling. Cooled coolant from the fuel cell 130 passing through condenser 150 is directed back to the fuel cell 130 via ducting represented by Stream 27. The fuel cell input coolant is pumped by fuel cell coolant pump 190 in a closed loop system, which contains an accumulator tank for surge capacity and for startup and shut down (not shown). The coolant may be a glycol-water mixture, another coolant mixture, or water only. Condenser 150 is preferably a multi-bundle condenser with an integral water collection tank and further configured to vent exhaust air and any other non-condensable reaction gases, including exhaust gases from the catalytic combustor 170 cooled by and exiting the heat exchanger 136 through ducting represented by Stream 10, via an exhaust blower 155 and exhaust stream 152. Generated or excess water from the fuel cell 130 not forming part of the closed cooling loop is pumped from the second condenser 150 by pump 144 through Stream 5 and returned to the process. Any excess water is discharged at discharge output 154. Coolant for the condenser 150 is preferably obtained from an intake strainer (not shown) coolant supply at intake 192, wherein the coolant may be the body of water within which the marine vessel is positioned, and circulated in an open loop via pump 194 and returned to the body of water via discharge output 196.

A second embodiment of the present invention is represented by FIGS. 4-5B, in which the fuel source is a sulfur-bearing petrodiesel fuel such as JP-8. In this embodiment, most primary components are configured, arranged and function in the manner described with respect to FIGS. 2-3B. However, in order to provide suitable efficiencies, optional sulfur guard bed 127 may be deployed to avoid poisoning the catalysts in reformer 126, water gas shift reactor 128, and fuel cell 130. The sulfur guard bed 127 operates to capture hydrogen sulfide from the sulfur-containing petrodiesel fuel by reacting the sulfur with hydrogen supplied from other components of the system. It is positioned between the output of the heat exchanger 136 at Stream 3A and as a partial introduction to Stream 6 feeding the auto-thermal reactor 126. Further, in this embodiment of the invention, the fuel cell hydrogen of Stream 19 is split into two streams; a minor stream through ducting represented by Stream 25 is redirected to the sulfur guard bed 127 to aid in the conversion of the sulfur in the fuel to hydrogen sulfide and subsequent absorption of any hydrogen sulfide produced. In order to increase the pressure of minor Stream 25 to the pressures at which other fuel processor components operate, a means of compressing that stream is required. One means of accomplishing this is via the use of turbo-compressor 120. In this embodiment, a portion of high-pressure gas, largely nitrogen, discharged from oxygen membrane separator 122 is directed via discharge 158 through the turbo-compressor 120 to discharge output 159. Another suitable means of providing a minor stream of hydrogen to sulfur guard bed 127 would be via the use of a small water electrolysis unit (not shown). Different reactor catalysts and/or operating conditions would be employed in the auto-thermal reactor 126 and water-gas shift reactor 128 in this embodiment using petrodiesel fuel.

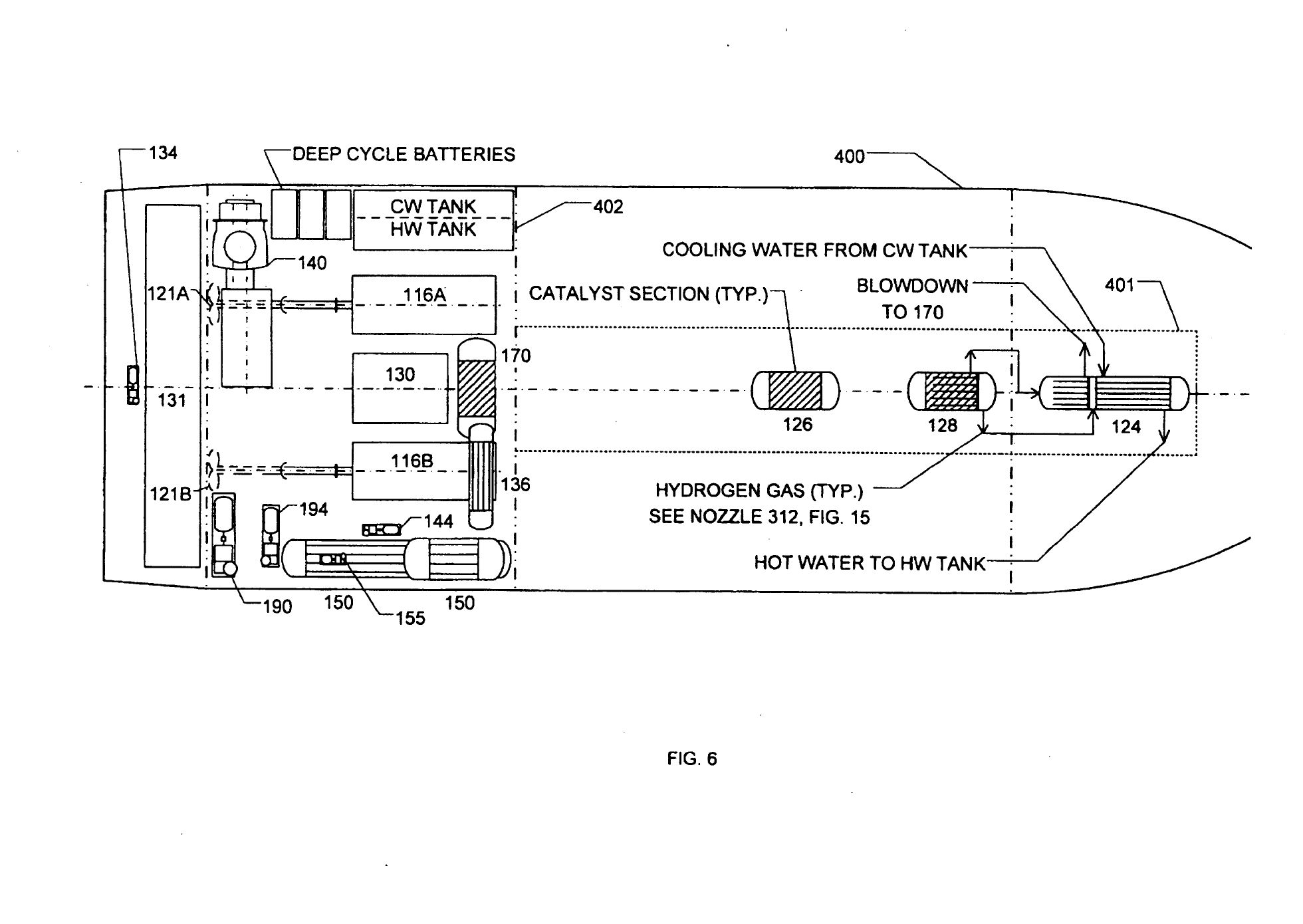

A third embodiment of the present invention is represented in FIGS. 6-7B, in which a biofuel is the fuel source, but the optional oxygen permeable membrane 122 is not used. This embodiment of the invention is substantially the same as the embodiment represented in FIGS. 2-3B. It is to be noted that while the embodiment of the invention represented in FIGS. 2-3B may produce the most effective fuel processor/fuel cell system, the embodiment of the invention represented in FIGS. 6-7B is also substantially effective. However, in this arrangement, air from compressor 140 is directed directly through Stream 20B to Stream 6 for introduction to the auto-thermal reactor 126, rather than introducing relatively pure oxygen thereto.

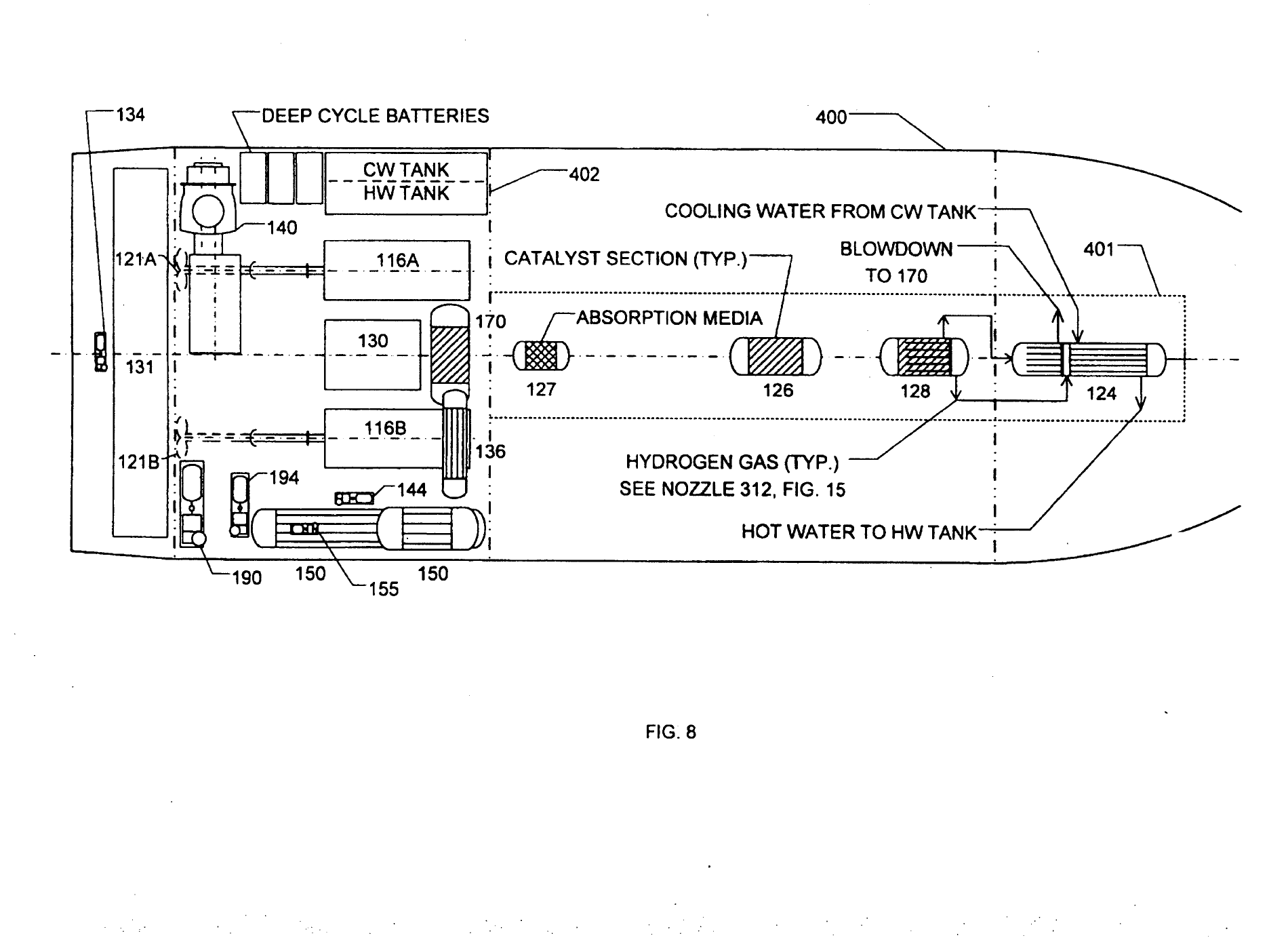

A fourth embodiment of the present invention is represented in FIGS. 8-9B, in which the optional oxygen membrane separator 122 and its related ducting and inlet and outlet connections are omitted, and the fuel source is a petrodiesel fuel. The embodiment of FIGS. 8-9B incorporate the components and operations described with respect to FIGS. 6-7B (i.e., no oxygen membrane separator 122), and further includes the sulfur guard bed 127 described with respect to FIGS, 4-5B.

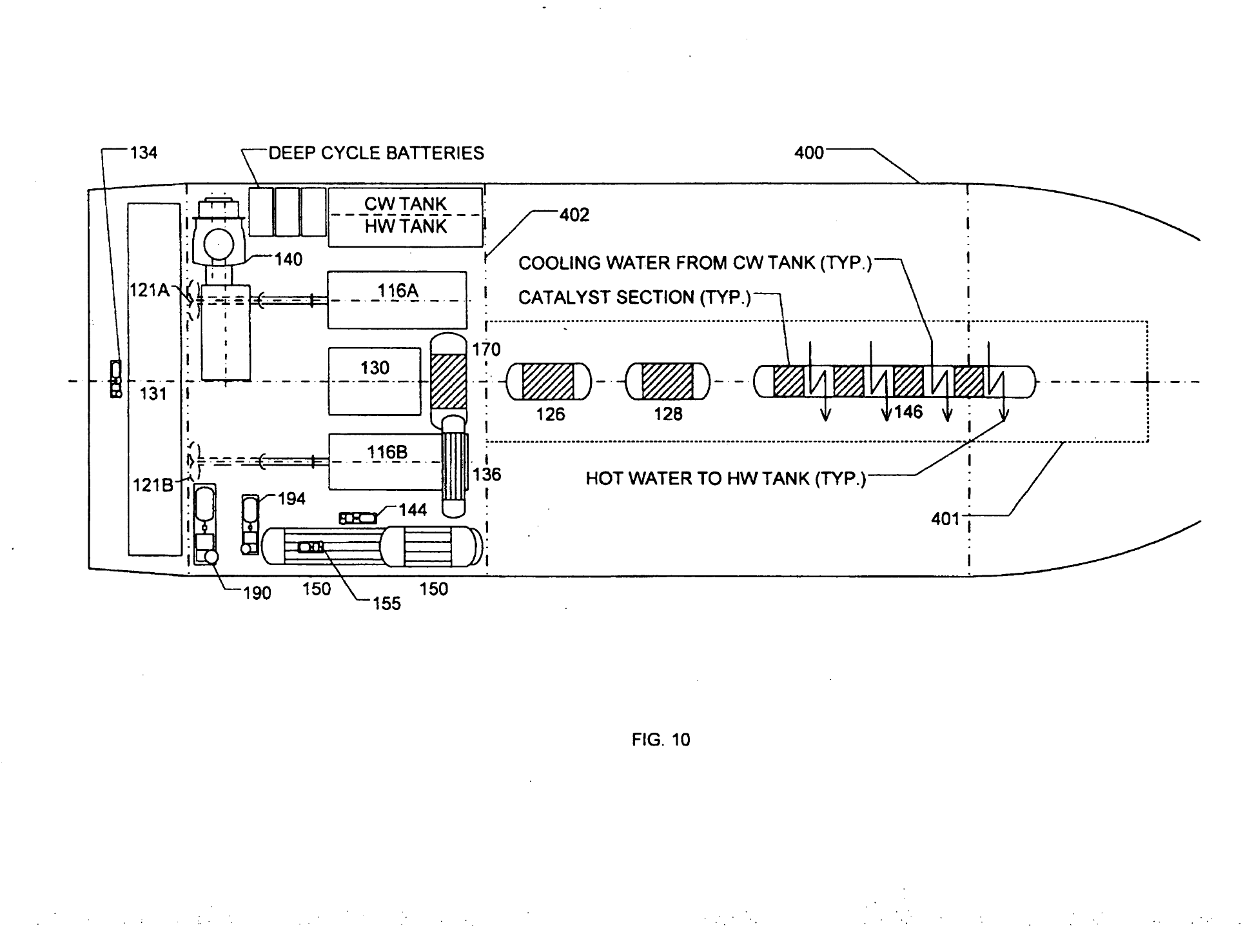

A fifth embodiment of the present invention is represented in FIGS. 10-11B, in which a biofuel is the fuel source, and the marine vessel 114 is relatively smaller, the fuel processor/fuel cell system 100 further including an otherwise optional secondary water-gas shift reactor 146 and omitting the oxygen membrane separator 122 and the hydrogen membrane separator 124. The optional secondary water-gas shift reactor 146 may be employed if it is determined to be necessary to generate more hydrogen for the fuel cell 130 than is generated by the auto-thermal reactor 126 and water-gas shift reactor 128 alone. It is to be noted that the optional secondary water-gas shift reactor 146 may do little to generate additional hydrogen. However, omission of the hydrogen membrane separator 124, if desired, requires use of the secondary gas-shift reactor 146 in order to substantially reduce the level of carbon monoxide that would otherwise enter the fuel cell 130 from the water-gas shift reactor 128. In this embodiment, the hydrogen/coolant mix carried by Stream 15 from desuperheater 182 via the water-gas shift reactor 128 enters the secondary water-gas shift reactor 146 for reaction. The secondary water-gas shift reactor 146 may be a reactor similar to the auto-thermal reactor 126 and the water-gas shift reactor 128, and is shown as such in FIGS. 11A-11B; however, it is preferably staged, as shown in FIG. 10, with an alternating series of cooling coils to control the exothermic reactions occurring therein and thereby ensure substantial conversion of carbon monoxide to carbon dioxide.

With continuing reference to FIGS. 10-11B, the fifth embodiment of the present invention is arranged and functions substantially in accordance with the operation of the embodiment of the invention represented in FIGS. 6-7B, except that the hydrogen membrane separator 124 and its corresponding ducting and inlet and outlet connections have been removed. Further, the fuel processor/fuel cell system 100 of this embodiment directs all output from the water-gas shift reactor 128 through Stream 12 to desuperheater 182 and then to Stream 15 for the feed of all the reaction gases to the input of the secondary water-gas shift reactor 146. Stream 29 is eliminated in this embodiment as no reaction gases from the water-gas shift reactor 128 are forwarded directly to the fuel cell 130. Instead, those reaction gases are further reacted to convert carbon monoxide to carbon dioxide. The output of the secondary water-gas shift reactor 146 is directed via Stream 16 to Stream 19 for eventual input to the fuel cell 130. Water split from Stream 13 to ducting represented by Stream 33 is used to control the exotherms in a staged reaction sequence (shown in FIG. 10) in the secondary water-gas shift reactor 146. The used hot water is transferred through ducting represented by Stream 35 to outlet 156, which may be directed to the vessel's potable hot water tank or other suitable on-board uses as described previously. Further, exhaust from the anode chamber 162 of the fuel cell 130 is directed through Stream 36 to the catalytic combustor 170 for combustion of residual carbon monoxide and un-reacted hydrogen from the fuel cell 130.

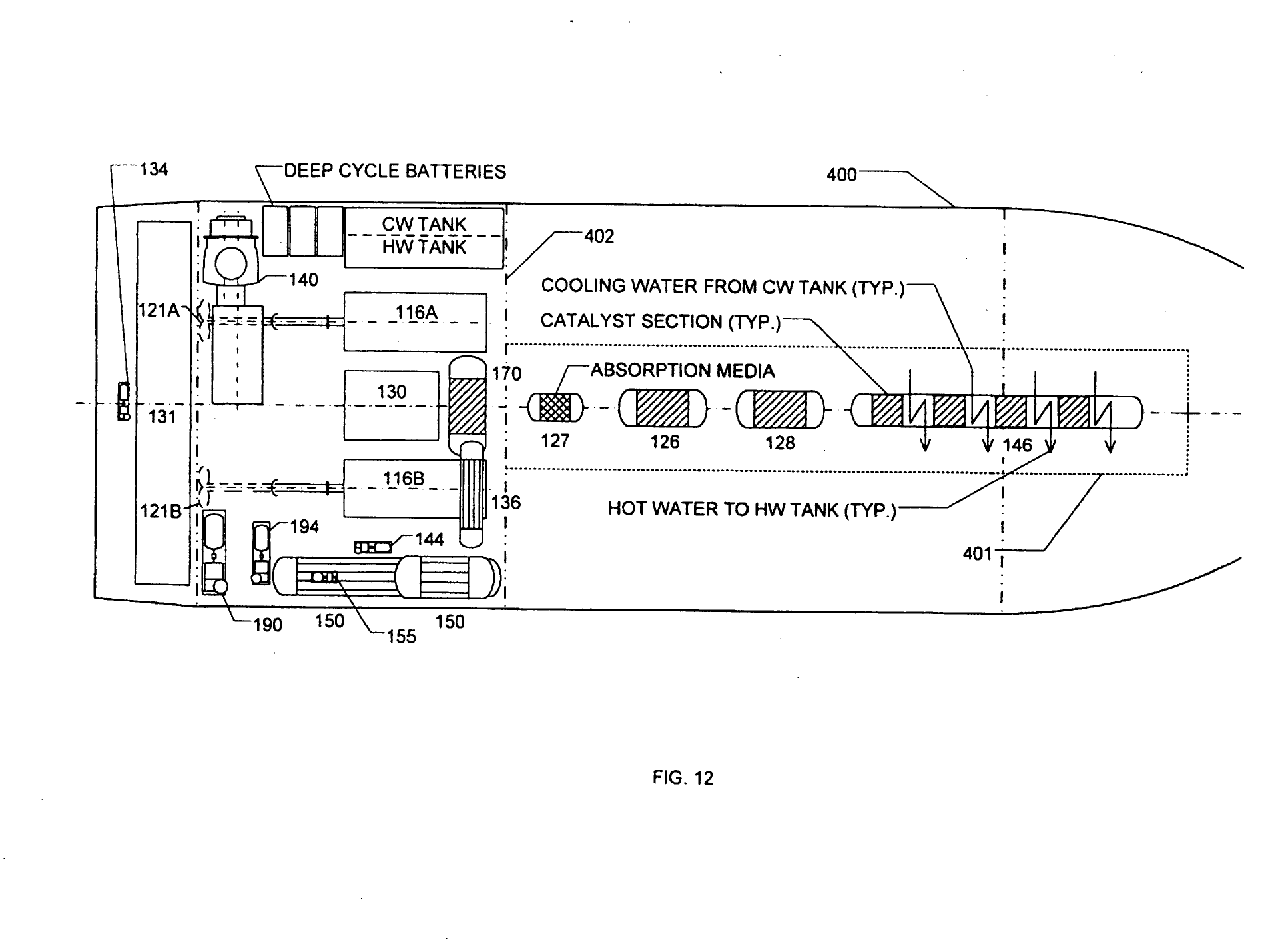

A sixth embodiment of the present invention is represented in FIGS. 12-13B, in which a petrodiesel is the fuel source, and the marine vessel 114 is relatively smaller, the fuel processor/fuel cell system 100 further including the optional secondary water-gas shift reactor 146 and omitting the oxygen membrane separator 122 and the hydrogen membrane separator 124. The embodiment of FIGS. 12-13B incorporate the components and operations described with respect to FIGS. 10-11B, and further includes the sulfur guard bed 127 described with respect to FIGS. 4-5B, except that in lieu of a turbo-compressor compressing an essentially pure, yet minor, stream of hydrogen, a small blower may be used to compress a small stream of hydrogen bearing gas, represented by Stream 25, from Stream 19 comprising the feed from the secondary water-gas shift reactor 146 to the fuel cell 130.

As illustrated in simplified form in FIG. 14, the primary components of the fuel processor/fuel cell system 100 are embodied in mechanical devices, electrical components and computing systems including hardware and software. The fuel supply 132 and air supply 138 supply fuel and air to the fuel processor system 500 comprising components other than the fuel cell 130. The fuel processor system 500 and the fuel cell 130 are managed and controlled by a variety of process sensors, controllers, and fuel safety control systems, represented generally as control system 502, and by thermal and waste heat management module 504. The thermal and waste heat management module 504 will manage pumps, heat exchangers, condensers, compressors and the like. The energy output from the fuel cell 130 is directed to a DC/DC Converter 508 and to a variety of DC loads and deep cycle marine battery system 512 at appropriate DC voltages (voltage control devices not shown), thence to a DC/AC Inverter 510. The modified electrical power transmitted therefrom is then directed to a variety of AC loads at various voltages (voltage control devices not shown), represented generally by load 514, to be serviced. The power conditioning and electronics side of the system 100 are managed and controlled by electronics controller 516, which may or may not communicate directly with control system 502. All controllers may be managed by master controller 518. Those skilled in the art will recognize that various control systems and interconnections may be employed to manage the safe functioning of the fuel processor/fuel cell system 100 for the particular DC and AC loads to be serviced.

In basic operation as has been described previously in detail, the fuel supply 132 feeds fuel to the fuel processor system 500 which converts the fuel into hydrogen that is fed, along with air or a concentrated oxygen stream, to the fuel cell 130, which may be formed as a stack or stacks of individual fuel cells. The fuel cell 130 generates variable voltage and variable current DC electrical power. The DC/DC converter 508, controlled by electronics controller 516, changes the variable voltage and variable current DC electrical power into a controlled voltage. The controlled voltage DC power from the DC/DC converter 508 is inverted in DC/AC inverter 510 to appropriate voltages for “house” loads like a microwave (120 VAC) or an air conditioner (240 VAC). The deep cycle marine battery system 512 stores electrical power to start the fuel processor system 500 and run emergency and safety systems. System 512 may also power main and auxiliary propulsion motors. The control logic, safety, supervisory and management functions preferably reside in a digital programmable logic controller (PLC) that controls the startup, shutdown, operation and safety functions of the fuel processor system 500 and the electrical systems, including thermal and waste heat management module 504, process and fuel control system 502, power conditioning and electronics controller 516, and master controller 518. Master controller 518 will also preferably interface and communicate with other vessel electronic and control systems.

It is to be noted that the oxygen membrane separator 122, the hydrogen membrane separator 124, the auto-thermal reactor 126, the water-gas shift reactor 128 and the secondary water-gas shift reactor 146 may be of selectable size, type and arrangement. An example type of reactor arrangement is shown in FIG. 15, with related FIG. 16 showing a close-up of one membrane tube of the tube sheet of FIG. 15. Example reactor 300 includes a gas inlet nozzle 311 for receiving a gas to be modified to produce a gas of interest including for example, hydrogen. The reactor 300 further includes a gas outlet nozzle 312 for transferring the hydrogen gas to another component of the fuel processor/fuel cell system 100. A reaction products outlet nozzle 313 transfers reaction byproduct gases not to be directed to the fuel cell 130 out of the reactor 300. Reactor 300 includes a suitable catalyst 316 to lower the activation energy in reactions that produce hydrogen. If the reactor vessel 300 does not contain a catalyst, it is an example of a gas permeable membrane separator that can separate either oxygen or hydrogen, depending upon the porous substrates and membranes used. For example, referring to FIG. 3A, a product gas from the oxygen membrane separator 122 would be oxygen, Stream 4, and a product gas from the water-gas shift reactor 128 would be hydrogen, Stream 29. The identified inlet and outlet nozzles form a structural part of a pressure vessel 304 within which reaction and/or gas separation occurs. The pressure vessel 304 may be fabricated of any suitable material, but is preferably 316L stainless steel. The pressure vessel 304 may be joined to ducting or directly to other components of the fuel processor/fuel cell system 100 via entry and exit flanges 305A and 305B. Depending upon its relative position within the fuel processor train, flanges 305A and/or 305B may be replaced with dished heads and the spaces adjacent to the flanges or dished heads may contain heat exchange surface such as cooling coils containing cooling water to cool reaction gases. The pressure vessel 304 may be insulated with a high-temperature insulation blanket 308, which may be mineral wool or other suitable material, and with a low-temperature insulation blanket 309, which may be fiberglass or other suitable material. A watertight sheathing 310 may be wrapped around the pressure vessel 304 to minimize water intrusion that would compromise the insulation properties of insulation 309.

With continuing reference to FIG. 15 and specific reference to FIG. 16, the example reactor 300 includes a tube sheet 306 with one or more membrane tubes 314. Catalyst 316 is positioned on the exterior of the tubes 314. The tube sheet 306 is sealed welded to the vessel shell 304. The membrane tubes assemblies 307 are preferably formed as porous tubes with suitable thin film membranes configured to permit substantially only the desired gas to exit the vessel 300 via the outlet nozzle 312. The tubes 314 are further coated or treated with a micro film/thin film membrane 315 on an interior surface (case shown), exterior surface, or both, of the tubes 314, depending upon how the gas is configured to flow. The membrane 315 is designed to ensure only desired gases enter the tubes 314. That is, the membrane 315 is selected to be selectively permeable to the molecules of the desired gas. The oxygen and hydrogen permeable membrane configurations shown as “tubes” attached to a “tube sheet” are but one example of how these membranes can be configured—other shapes and structures are possible.

In operation when the reactor 300 is used for the hydrogen membrane separator 124, a gas mixture 301 from the water-gas shift reactor 128, enters the reactor 300 at inlet 311. It flows in the chamber between the entry flange 305A and the pressure vessel 304, coming first in contact with the catalyst 316 located outside of the tubes 314 of the tube sheet 306. The gas mixture 301 flows through the catalyst bed randomly packed with the catalyst 316. Reactions occur at the catalyst 316, producing hydrogen 302 and reaction byproduct gases 303. The molecules of reaction byproduct gases 303 are too large to pass through the tubes 314 and therefore pass through the remainder of the catalyst bed prior to exiting the pressure vessel 304 at byproduct outlet nozzle 313. The hydrogen gas 302 diffuses or otherwise passes through the membrane 315 into the interior of the tubes 314 and exits the pressure vessel 304 through the chamber between the pressure vessel 304 and the exit flange 305B to outlet nozzle 312. It is to be noted that there are transport mechanisms other than gas diffusion by which some of these membranes work, e.g., disassociation of the H₂ molecule and passage of protons and electrons through the membrane, much the way PEM fuel cell electrolyte membranes work. The reactors of the present invention are not intended to be limited to the example representation of FIGS. 15 and 16.

In the alternative, as previously noted, when the vessel 300 is an oxygen permeable membrane separator 122, the catalyst 316 will not be required as depicted in FIG. 15. Additionally, for the oxygen membrane separator 122, the desired gas 302 is oxygen, the byproduct gas 303 is largely nitrogen, and the membrane 315 is selected to maximize passage of oxygen molecules into the interior of the tubes 314. In all cases in which a catalyst is required, the catalyst 316 may be selected for the particular purpose. The catalyst may be of any shape or size, uniform or not, and is generally in pellet form. The catalyst may be randomly packed or coated on honeycombed ceramic substrates, such as the wash-coated substrates of the type manufactured by Corning, Inc., of Corning, N.Y. Such substrates are coated with a suitable catalyst as needed for the particular reaction of interest, including the water-gas shift reactors 128/146, the auto thermal reactor 126, and the optional sulfur guard bed 127. Construction similar to the optional embedded hydrogen permeable membrane in the water-gas-shift reactor 128 described in respect to FIGS. 2-3B, may be used for the hydrogen membrane separator 124.

As noted, the oxygen permeable membrane tubes may be composed of a porous substrate coated with an ultra-thin film, the membrane 315, on the inside. The same is true for the hydrogen permeable tubes, which may be composed of different porous substrates and membrane coatings. Two possible oxygen permeable membrane tube compositions for the porous substrate are 1) porous sintered ceramic of Yttrium Stabilized Zirconia; and 2) porous ceramic of Cerium Gadolinium Oxide, e.g. Ce_{0.8}Gd_{0.2}O_{1.9}. For the ultra-thin film of the oxygen permeable membrane, two examples are: 1) dense Perovskites doped with multi-metal oxides, e.g., Lanthanum—(Barium, Strontium or Calcium)—(Iron, Cobalt or Manganese)—(Nickel or Copper)—Oxides of the form L₁₋ₓAₓB_{1-y}C_{y}O₃, where A=Ba, Sr or Ca; B=Fe, Co or Mn; and C=Ni or Cu; and 2) CoFe₂O₄. For the hydrogen membrane separator 124, three possible hydrogen permeable membrane porous substrates are 1) sintered, porous 410 stainless steel, 2) porous ceramic and 3) porous Al₂O₃. A prime example of the ultra-thin film of the hydrogen permeable membrane is the metal Palladium.

It is to be noted that the fuel cell 130 illustrated and described herein is representative of an example version, which is preferably a Polymer Electrolyte Membrane (PEM) fuel cell. It is possible to configure PEM fuel cells to take advantage of spaces that are not normally very useful in a vessel, such as, but not limited to, the bow area. Fuel cell stacks can be fabricated in shapes to take advantage of such spaces and installed in those spaces with appropriate piping, tubing, power wiring and instrumentation and control wiring interconnecting such stacks with the balance of fuel cell stacks located elsewhere in the vessel, such as in the engine compartment. Such a fuel cell is desirable for use in a marine vessel as it can be operated at relatively low temperatures and does not contain complex auxiliary equipment and/or chemicals that could pose difficult safety and/or handling challenges in marine environments. As a result, the primary components of an integrated fuel processor/fuel cell system 100, such as the hydrogen separator 124, the auto-thermal reactor 126, the water-gas shift reactor 128, or the fuel cell 130 itself may be relatively small in size in comparison to some commercially available fuel cells on an equivalent integrated system/electrical output basis. Further, as noted, the present invention contemplates fabricating each of the primary components and their supporting components, with a relatively slim profile such that the entire fuel processor/fuel cell system 100 may fit within the conventional propulsion system footprint of the marine vessel 114. That is, the components of the fuel processor/fuel cell system may be fabricated relatively long and narrow to fit within the available engine room and other spaces as further described herein for a typical marine vessel in the size range of interest. Examples of such configurations are shown in FIGS. 2, 4, 6, 8, 10, and 12. In effect, among other components of the present invention, the fuel cell 130, which may be in the form of a stack or stacks of fuel cells, or a portion thereof, may be configured for placement within one or more areas outside of the engine room of the marine vessel, including, but not limited to, the bow area and curved sides. Alternative types of fuel cells previously noted that may be considered for use as the fuel cell 130 of the present invention include: Phosphoric Acid fuel cells, Molten Carbonate fuel cells, Solid Oxide fuel cells, Alkaline fuel cells, Direct Methanol fuel cells, Regenerative fuel cells, Zinc-Air fuel cells, and Protonic Ceramic fuel cells. The fuel cell selected may require different fuels and/or different fuel processing arrangements.

In the embodiment of the fuel processor/fuel cell system 100 of the present invention illustrated in FIGS. 2-13B, the primary components noted may be selected from a variety of options. For example, the auto-thermal reactor 126 may be an essentially adiabatic ethanol reformer, where the final composition reflects the minimization of Gibbs free energy. The water-gas shift reactor 128 may also be an essentially adiabatic reactor as may be the optional secondary water-gas shift reactor 146.The thin film palladium hydrogen permeable membrane version of the hydrogen separator 124 may be characterized as separating hydrogen as a function of feed pressure, temperature and hydrogen feed composition. The membrane of the hydrogen separator 124 may be sized based on an assumption made regarding membrane hydrogen permeance. The water-gas shift reactor 128 may be sized assuming that the products from the auto thermal reactor 126 are not in equilibrium and the incorporation of hydrogen permeable membrane technology in the water-gas shift reactor will remove hydrogen formed via the water gas shift reaction, thereby forcing the reaction in such as way as to favor production of hydrogen in concentrations greater than that attainable at equilibrium.

The fuel processor/fuel cell system 100 of the present invention contemplates use of ethanol or a biodiesel fuel as a fuel source in the process of hydrogen generation and mixtures of ethanol and biodiesel to improve the cold handling properties of straight biodiesel. The fuel processor/fuel cell system 100 minimizes preheating of catalysts or other components to the extent just needed to initiate the operation of the auto thermal reactor 126. To that end, the fuel processor/fuel cell system 100 preferably includes heat sources and sinks represented by the condenser and heat exchangers previously described herein, so as to minimize heat collection, storage and distribution systems. It is further contemplated that water will be recycled within the system to the extent necessary to maintain a water balance in the primary components, including the fuel cell 130. The fuel processor/fuel cell system 100 contemplates the inclusion of integrated heat recovery with exothermic and endothermic catalysts as suitable for the auto thermal reactor 126 and the one or more water-gas shift reactors. These catalysts are preferably nested together to maximize heat utilization. Additionally, one or more stacks of structures operating as the fuel cell 130 and supporting equipment are preferably insulated and electrically heated to prevent freezing in cold weather when not in use.

The present invention is a fuel processor/fuel cell system capable of integration into an existing structure including, but not limited to, a marine vessel. While the present invention has been described with particular reference to certain embodiments of the primary components of the system and their particular interaction, it is to be understood that it includes all reasonable equivalents thereof as defined by the following appended claims.

What is claimed is:

1. A system for powering a marine vessel with a fuel cell, the marine vessel including an electric propulsion mechanism, the system comprising:
a. an auto thermal reactor adapted to receive a fuel source and to convert the fuel source into a mixture including hydrogen and one or more other components;
b. a water-gas shift reactor coupled to the auto thermal reactor and adapted to concentrate the hydrogen from the one or more other components;
c. an oxygen membrane separator to concentrate oxygen from an oxygen source and reduce the concentration of nitrogen in the fuel processor system;
d. a hydrogen membrane separator to concentrate and purify the hydrogen produced in the auto thermal reactor and the water-gas shift reactor; and
e. a fuel cell arranged to receive the hydrogen and the oxygen and generate electricity therefrom, wherein the fuel cell is couplable to the electric propulsion mechanism of the marine vessel.

2. The system as claimed in claim 1 further comprising a multi-stage compressor for compressing air including oxygen as the oxygen source, wherein the compressor is coupled to the fuel cell.

3. The system as claimed in claim 2 wherein the oxygen membrane separator is coupled to the multi-stage compressor.

4. The system as claimed in claim 3 wherein the oxygen membrane separator is coupled to the auto thermal reactor.

5. The system as claimed in claim 1 further comprising a second gas-water shift reactor coupled between the gas-water shift reactor and the hydrogen membrane separator.

6. The system as claimed in claim 1 wherein the auto thermal reactor is an adiabatic reactor.

7. The system as claimed in claim 1 wherein the gas-water shift reactor is an adiabatic reactor.

8. The system as claimed in claim 1 wherein the fuel source is a biofuel.

9. The system as claimed in claim 8 wherein the biofuel is selected from ethanol and biodiesel.

10. The system as claimed in claim 1 wherein the auto thermal reactor, the water-gas shift reactor and the fuel cell are shaped to conform to the internal dimensions of the area of the marine vessel including the propulsion system.

11. The system as claimed in claim 1 wherein the oxygen permeable membrane, auto thermal reactor, water gas shift reactor(s) and integral cooling loops and the hydrogen permeable membrane are shaped and assembled in a manner that conforms to the available space bounded by the bottom of the cabin sole, structural stringers and bulkheads within the marine vessel.

12. The system as claimed in claim 11 wherein the marine vessel includes access hatches to gain access to the system, and a cooling apparatus to cool the system.

13. The system as claimed in claim 1 further comprising a condenser system for condensing water vapor exhausted by the fuel cell, the condenser system including means for collecting and returning condensed water vapor as a coolant to the fuel cell and venting non-condensable gases to the atmosphere via devices that preclude the introduction of water or salt air into the system.

14. The system as claimed in claim 1 further comprising an air filter and scrubber to reduce the introduction of particulates, salt and other air borne contaminants into the oxygen permeable membrane separator.

15. The system as claimed in claim 1 wherein the auto thermal reactor includes one or more catalysts to lower reaction activation energies and promote the conversion of the fuel source into hydrogen, wherein the one or more catalysts are selected to have exothermic and endothermic characteristics and nested for heat recovery therein.

16. The system as claimed in claim 1 further comprising a fluid source for supplying steam to the water-gas shift reactor.

17. The system as claimed in claim 16 wherein the steam is at least partially supplied by the output of water vapor from the fuel cell.

18. The system as claimed in claim 1 wherein interconnecting fuel processor piping is on the one hand hard piped to impede unauthorized intrusion of contaminants and on the other hand, contains engineered internal, scoured grooves that can be cut open for service by authorized personnel.

19. The system as claimed in claim 1 wherein interconnecting fuel processor piping is insulated and electrically heat traced using DC electrical power from the fuel cell, or from shore power during periods when the vessel is not in use, for protection from freezing during cold weather periods.

20. The system as claimed in claim 1 wherein at least a portion of the fuel cell is configured for placement within one or more areas outside of the engine compartment of the marine vessel.

21. The system as claimed in claim 1 further comprising a sulfur guard bed coupled between the fuel source and the auto thermal reactor.

22. A system for powering a marine vessel with a fuel cell, the marine vessel including an electric propulsion mechanism, the system comprising:
a. an auto thermal reactor adapted to receive a fuel source and to convert the fuel source into a mixture including hydrogen and one or more other components;
b. a water-gas shift reactor coupled to the auto thermal reactor and adapted to concentrate the hydrogen from the one or more other components;
c. a hydrogen membrane separator to concentrate and purify the hydrogen produced in the auto thermal reactor and the water-gas shift reactor; and
d. a fuel cell arranged to receive the hydrogen from the hydrogen membrane separator, to receive oxygen, and to generate electricity therefrom, wherein the fuel cell is couplable to the electric propulsion mechanism of the marine vessel.

23. The system as claimed in claim 22 further comprising a sulfur guard bed coupled between the fuel source and the auto thermal reactor.

24. The system as claimed in claim 22 wherein at least a portion of the fuel cell is configured for placement within one or more areas outside of the engine compartment of the marine vessel.

25. A system for powering a marine vessel with a fuel cell, the marine vessel including an electric propulsion mechanism, the system comprising:
a. an auto thermal reactor adapted to receive a fuel source and to convert the fuel source into a mixture including hydrogen and one or more other components;
b. a first water-gas shift reactor coupled to the auto thermal reactor and adapted to concentrate the hydrogen from the one or more other components;
c. a secondary water-gas shift reactor coupled to the first water-gas shift reactor to purify the hydrogen produced in the auto thermal reactor and the first water-gas shift reactor; and
d. a fuel cell arranged to receive the hydrogen from the secondary water-gas shift reactor, to receive oxygen, and to generate electricity therefrom, wherein the fuel cell is couplable to the electric propulsion mechanism of the marine vessel.

26. The system as claimed in claim 25 further comprising a sulfur guard bed coupled between the fuel source and the auto thermal reactor.

27. The system as claimed in claim 25 wherein at least a portion of the fuel cell is configured for placement within one or more areas outside of the engine compartment of the marine vessel.
